(19) United States
(12) Patent Application Publication
(10) Pub. No.: US 2024/0389813 A1
(43) Pub. Date: Nov. 28, 2024

(54) WASHING METHOD AND DEVICE, BASE STATION AND STORAGE MEDIUM

(71) Applicant: Beijing Roborock Technology Co., Ltd., Changping District, Beijing (CN)

(72) Inventor: Pan CHENG, Changping District, Beijing (CN)

(73) Assignee: Beijing Roborock Technology Co., Ltd., Changping District, Beijing (CN)

(21) Appl. No.: 18/687,700

(22) PCT Filed: Jul. 13, 2022
(86) PCT No.: PCT/CN2022/105562

§ 371 Date: Feb. 28, 2024

(30) Foreign Application Priority Data
Aug. 31, 2021 (CN) 202111014045.0

(51) Int. Cl. A47L 9/28; A47L 11/40

(52) U.S. Cl. CPC A47L 9/2873; A47L 11/4011; A47L 2201/028; A47L 2201/06

(57) ABSTRACT

Embodiments of the present disclosure provide a washing method and device, a base station, and a storage medium. The washing method is used for a base station which is to be used cooperatively with a cleaning robot. The base station includes a base station body and a washing assembly. The washing assembly is movably disposed on the base station body. The washing method includes: acquiring second relative position information of the washing assembly and the base station body; and controlling an initial running direction of the washing assembly according to the second relative position information.

### CROSS-REFERENCE TO RELATED APPLICATION

The present application is a 35 U.S.C. 371 national phase application of PCT International Application No. PCT/CN2022/105562 filed on Jul. 13, 2022, which claims priority to Chinese Patent Application No. 202111014045.0, filed on Aug. 31, 2021, which is incorporated herein by reference in its entirety.

### TECHNICAL FIELD

The present disclosure relates to the field of intelligent control technologies, and in particular, to a washing method and device, a base station, and a storage medium.

### BACKGROUND

An existing base station is usually provided with a movable washing assembly for washing a flat mop cloth of a sweeping-and-mopping integrated cleaning robot, and is also provided with a liquid discharge device for providing a cleaning liquid for washing the flat mop cloth. However, an existing washing method presents the problems of poor cleaning effect and energy waste.

### SUMMARY

In view of this, embodiments of the present disclosure provide a washing method and device, a base station, and a storage medium, which are used to improve a washing effect of the base station and save energy.

Embodiments according to a first aspect of the present disclosure provide a washing method for a base station to be used cooperatively with a cleaning robot. The base station includes a base station body, a washing assembly, and a liquid discharge device. The washing assembly is movably disposed on the base station body, and includes a first washing component and a second washing component which are disposed side-by-side and configured to interfere with a cleaning system of the cleaning robot to remove debris on the cleaning system. A cleaning liquid discharged from the liquid discharge device is used to wash the cleaning system.

The washing method includes: acquiring first relative position information of the first washing component and the second washing component; acquiring a running direction of the washing assembly relative to the base station body; and controlling a working state of the washing assembly and a working state of the liquid discharge device according to the first relative position information and the running direction.

Further, the first washing component includes a washing squeegee, and the second washing component is rotatable around a rotation axis. The step of controlling the working state of the washing assembly includes: controlling a rotation state of the second washing component.

Further, the step of controlling the working state of the washing assembly and the working state of the liquid discharge device according to the first relative position information and the running direction includes, when the second washing component is located in front of the first washing component in a movement direction of the washing assembly: controlling the second washing component to rotate and controlling the liquid discharge device to work.

Further, the liquid discharge device is disposed side-by-side with the first washing component and the second washing component, and the step of controlling the liquid discharge device to work includes: controlling the liquid discharge device, which is located in front of the first washing component in the movement direction, to work.

Further, the washing method further includes: acquiring second relative position information of the washing assembly and the base station body; and controlling an initial running direction of the washing assembly according to the second relative position information.

Further, the washing method further includes: determining whether a distance between the washing assembly and a first side edge of the base station body is greater than or equal to a distance between the washing assembly and a second side edge of the base station body; and controlling the washing assembly to move in the direction of the first side edge of the base station body when the distance between the washing assembly and the first side edge of the base station body is greater than or equal to the distance between the washing assembly and the second side edge of the base station body.

Further, the washing method further includes, after the washing assembly arrives at the first side edge of the base station body: controlling the washing assembly to move in the direction of the second side edge of the base station body and controlling the liquid discharge device to cease operation.

Further, the washing method further includes: controlling the washing assembly to move in the direction of and arrive at a preset position of the base station body in response to a washing end instruction.

Further, the step of acquiring the second relative position information of the washing assembly and the base station body includes: acquiring a second relative position relationship between the washing assembly and the base station body via a sensing device and a signal transmission device which are disposed on the base station body and the washing assembly, respectively.

Further, a first sensing device is disposed near the first side edge of the base station body, a second sensing device is disposed near the second side edge of the base station body, and a third sensing device is disposed near the preset position of the base station body.

The step of acquiring the second relative position relationship between the washing assembly and the base station body via the sensing device and the signal transmission device which are disposed on the base station body and the washing assembly, respectively, includes:
determining that the washing assembly arrives at the first side edge of the base station body when the signal transmission device is detected by the first sensing device;
determining that the washing assembly arrives at the second side edge of the base station body when the signal transmission device is detected by the second sensing device; and
determining that the washing assembly arrives at the preset position of the base station body when the signal transmission device is detected by the third sensing device.

Further, the base station further includes a cleaning tank located below the washing assembly. The washing method further includes acquiring information on a liquid level in the cleaning tank; and controlling the working state of the liquid discharge device based on the information on the liquid level.

Embodiments according to a second aspect of the present disclosure provide a washing apparatus for a base station to be used cooperatively with a cleaning robot. The base station includes a base station body, a washing assembly, and a liquid discharge device. The washing assembly is movably disposed on the base station body, and includes a first washing component and a second washing component which are disposed side-by-side and configured to interfere with a cleaning system of the cleaning robot to remove debris on the cleaning system. A cleaning liquid discharged from the liquid discharge device is used to wash the cleaning system.

The washing device includes:
a first acquiring module, configured to acquire first relative position information of the first washing component and the second washing component;
a second acquiring module, configured to acquire a running direction of the washing assembly relative to the base station body; and
a first processing module, configured to control a working state of the washing assembly and a working state of the liquid discharge device according to the first relative position information and the running direction.

Further, the first washing component includes a washing squeegee, and the second washing component is rotatable around a rotation axis.

The first processing module includes:
a first processing unit, configured to control a rotation state of the second washing component.

Further, the first processing module includes:
a second processing unit, configured to, when the second washing component is located in front of the first washing component in a movement direction of the washing assembly, control the second washing component to rotate; and control the liquid discharge device to work.

Further, the liquid discharge device is disposed side-by-side with the first washing component and the second washing component; and the liquid discharge device is controlled to work.

The second processing unit includes:
a first processing sub-unit, configured to activate the liquid discharge device, which is located in front of the first washing component in the movement direction.

Further, the washing device further includes:
a third acquiring module, configured to acquire second relative position information of the washing assembly and the base station body; and
a second processing module, configured to control an initial running direction of the washing assembly according to the second relative position information.

Further, the washing device further includes:
a detection module, configured to determine whether a distance between the washing assembly and a first side edge of the base station body is greater than or equal to a distance between the washing assembly and a second side edge of the base station body; and
a second processing module, including a second processing sub-unit configured to control the washing assembly to move in the direction of the first side edge of the base station body when the distance between the washing assembly and the first side edge of the base station body is greater than or equal to the distance between the washing assembly and the second side edge of the base station body.

Further, the second processing module further includes: a third processing sub-unit configured to, after the washing assembly arrives at the first side edge of the base station body, control the washing assembly to move in the direction of the second side edge of the base station body and control the liquid discharge device to cease operation.

Further, the washing device further includes: a third processing module configured to control the washing assembly to move in the direction of and arrive at a preset position of the base station body in response to a washing end instruction.

Further, the third acquiring module acquires a second relative position relationship between the washing assembly and the base station body via a sensing device and a signal transmission device which are disposed on the base station body and the washing assembly, respectively.

Further, a first sensing device is disposed near the first side edge of the base station body, a second sensing device is disposed near the second side edge of the base station body, and a third sensing device is disposed near the preset position of the base station body.

The third acquiring module includes:
a first determining unit, configured to determine that the washing assembly arrives at the first side edge of the base station body when the signal transmission device is detected by the first sensing device;
a second determining unit, configured to determine that the washing assembly arrives at the second side edge of the base station body when the signal transmission device is detected by the second sensing device; and
a third determining unit, configured to determine that the washing assembly arrives at the preset position of the base station body when the signal transmission device is detected by the third sensing device.

Further, the base station further includes a cleaning tank located below the washing assembly.

The washing device further includes:
a fourth acquiring module, configured to acquire information on a liquid level in the cleaning tank; and
a fourth processing module, configured to control the working state of the liquid discharge device based on the information on the liquid level.

Embodiments according to a third aspect of the present disclosure provide a base station. The base station includes a processor and a memory. The memory is configured to store an operation instruction. The processor is configured to perform the washing method according to the first aspect above by invoking the operation instruction.

Embodiments according to a fourth aspect of the present disclosure provide a computer-readable storage medium storing therein a computer program. The computer program, when executed by a processor, implements the washing method according to the first aspect.

According to the washing method and apparatus, the base station, and the computer-readable storage medium provided by the embodiments of the present disclosure, the first relative position information of the first washing component and the second washing component is comprehensively considered together with the second relative position information of the washing assembly and the base station body, such that the working state of the washing assembly is calibrated to the structure and a movement direction of a cleaning assembly itself, and the working state of the liquid discharge device is calibrated to the structure and the working state of the cleaning assembly. Thus, not only are the cleaning efficiency and the cleaning effect of the washing assembly improved, but also the energy utilization is improved, thereby saving energy and reducing the cleaning cost, and hence being suitable for promotion and application.

### BRIEF DESCRIPTION OF THE DRAWINGS

To more clearly describe the technical solutions in embodiments of the present disclosure or the related art, the following briefly introduces the accompanying drawings required for describing the embodiments or the related art. It is noted that the accompanying drawings in the following description show some embodiments of the present disclosure. Those of ordinary skill in the art may still derive other drawings from these accompanying drawings with minimal creative effort.

FIG. 1 is a structural schematic diagram of a cleaning robot system according to an alternative embodiment of the present disclosure;

FIG. 2 is a structural schematic diagram of a cleaning robot according to an alternative embodiment of the present disclosure;

FIG. 3 is a structural schematic diagram of the embodiment shown in FIG. 2 from one perspective;

FIG. 4 is a partial exploded view of the embodiment shown in FIG. 3:

FIG. 5 is a structural schematic diagram of a base station according to a first alternative embodiment of the present disclosure;

FIG. 6 is a structural schematic diagram of a washing assembly according to the first alternative embodiment of the present disclosure;

FIG. 7 is a partial structural schematic diagram of a washing assembly according to a second alternative embodiment of the present disclosure;

FIG. 8 is a structural schematic diagram of the embodiment shown in FIG. 5 in one direction;

FIG. 9 is a schematic flowchart of a washing method according to an alternative embodiment of the present disclosure;

FIG. 10 is a schematic block diagram of a washing device according to an alternative embodiment of the present disclosure; and

FIG. 11 is an electrically structural schematic diagram of a base station according to an alternative embodiment of the present disclosure.

### REFERENCE NUMERALS IN THE FIGURES

10 cleaning robot; 110 robot body; 111 forward portion; 112 rearward portion; 120 perception system; 121 determining device; 122 buffer; 130 control module; 140 driving system; 141 driving wheel module; 142 driven wheel; 150 cleaning system; 151 dry cleaning system; 152 side brush; 153 wet cleaning system; 1531 cleaning head; 1532 driving unit; 1533 driving platform; 1534 supporting platform; 160 energy system; 170 human-computer interaction system; 20 base station; 21 base station body; 211 cleaning tank; 212 mounting tank; 22 sensing device; 221 first sensing device; 222 second sensing device; 223 third sensing device; 23 charging contact; 24 guide portion; 30 washing assembly; 31 first washing component; 32 second washing component; 33 support; 34 driving device; 35 liquid discharge device; 500 washing device; 502 first acquiring module; 504 second acquiring module; 506 first processing module; 601 processing device; 602 ROM; 603 RAM; 604 bus; 605 I/O interface; 606 input device; 607 output device; 608 storage device; and 609 communication device.

### DETAILED DESCRIPTION

Embodiments of the present disclosure are described in detail below, and the examples of the embodiments are shown in the accompanying drawings, in which the same or similar reference numerals denote the same or similar elements or elements having the same or similar functions. The following embodiments described with reference to the accompanying drawings are exemplary and only intended to explain the present disclosure, and may not be construed as any limitation to the present disclosure.

It may be understood by those skilled in the art that the singular forms “a”, “an”, “said”, and “the” used herein may also include the plural forms, unless expressly stated. It should be further understood that the term “include” used in the description of the present disclosure specifies the presence of stated features, integers, steps, operations, elements, and/or components, but does not preclude the presence or addition of one or more other features, integers, steps, operations, elements, components, and/or groups thereof. It should be understood that when an element is referred to as being “connected to” or “coupled to” another element, the element may be directly “connected to” or “coupled to” the other element, or there may be an intermediate element. In addition, the term “connected” or “coupled” used herein may include wireless connection or wireless fused connection. The term “and/or” used herein includes all or any unit and all combinations of one or more associated items as listed.

For clearer descriptions of technical solutions and advantages of the present disclosure, the embodiments of the present disclosure are described in further detail below with reference to the accompanying drawings.

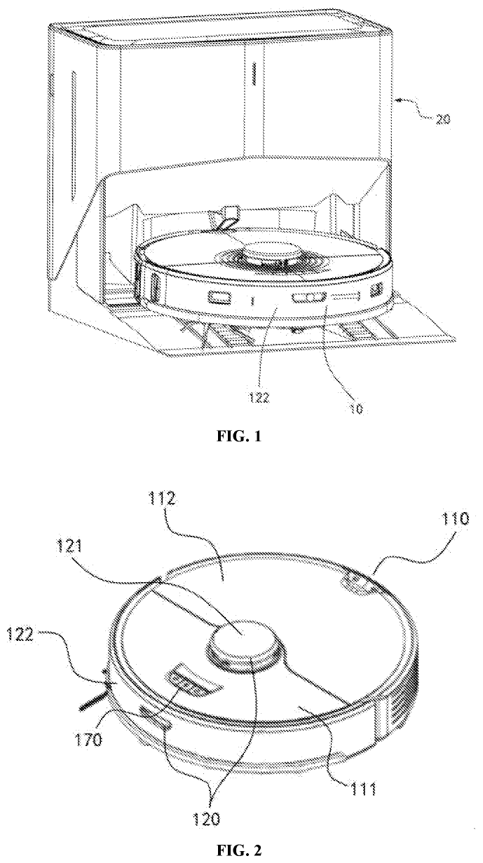

The embodiments of the present disclosure provide a possible application scenario, which includes a base station. Specifically, as shown in FIG. 1, this scenario may be a cleaning robot system. The cleaning robot system includes a base station 20 and a cleaning robot 10. That is, the base station 20 is used cooperatively with the cleaning robot 10, and the cleaning robot 10 may be an automatic moving robot.

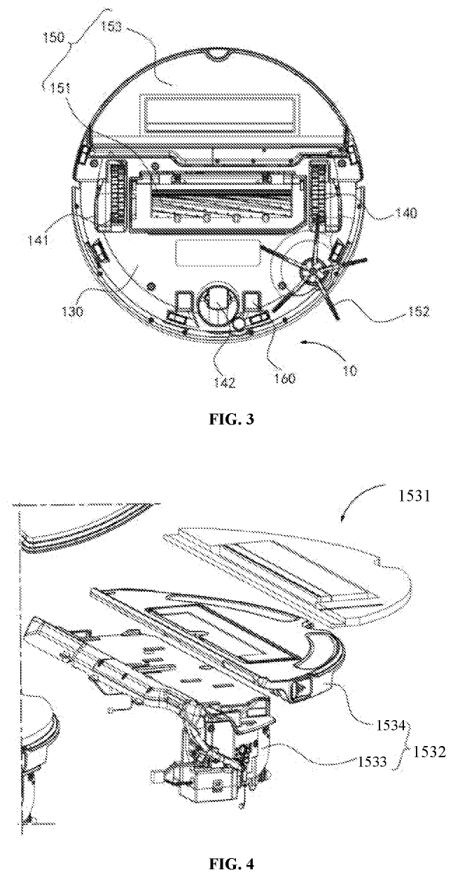

Further, as shown in FIGS. 2 and 3, the cleaning robot 10 may include a robot body 110, a perception system 120, a control module 130, a driving system 140, a cleaning system 150, an energy system 160, and a human-computer interaction system 170. It may be understood that the cleaning robot 10 may be an automatic moving cleaning robot or another cleaning robot that meets requirements. The automatic moving cleaning robot is an apparatus that automatically performs a cleaning operation in a certain area to be cleaned without user intervention. When the automatic moving cleaning robot starts working, an automatic moving cleaning device leaves the base station 20 for performing a cleaning task. When the automatic moving cleaning robot 10 completes the cleaning task or encounters a situation in which the cleaning task needs to be suspended, the automatic moving cleaning robot 10 may return to the base station 20 for charging or other operations.

As shown in FIG. 2, the robot body 110 includes a forward portion 111 and a backward portion 112, and the robot body 110 may have an approximate circular shape (both the forward portion and the backward portion being circular), and may also have other shapes, including, but not limited to, an approximate D-shape with a square forward portion and a circular backward portion, or a rectangular or square shape with a square forward portion and a square backward portion.

As shown in FIG. 2, the perception system 120 includes: a position-determining device 121 located on the robot body 110; a collision sensor and a proximity sensor disposed on a buffer 122 on the forward portion 111 of the robot body 110; a cliff sensor disposed at a lower part of the robot body 110; and sensing devices, such as a magnetometer, an accelerometer, a gyroscope, and an odometer, disposed inside the robot body 110 and configured to provide various position information and movement-state information of the robot for the control module 130. The position-determining device 121 includes, but is not limited to, a camera and a laser distance sensor (LDS).

As shown in FIG. 2, the forward portion 111 of the robot body 110 may bear the buffer 122. During the cleaning process, when a driving wheel module 141 propels the cleaning robot 10 forward on the floor, the buffer 122 detects one or more events in a travelling path of the cleaning robot 10 via a sensor system disposed thereon, such as an infrared sensor. The cleaning robot 10 may control the driving-wheel module 141 on the basis of the events detected by the buffer 122, such as obstacles and walls, such that the cleaning robot 10 responds to the events by, for example, moving away from the obstacles.

The control module 130 is disposed on a main circuit board inside the robot body 110, and includes a computing processor, such as a central processing unit or an application processor, that is in communication with a non-transitory memory such as a hard disk, a flash memory or a random-access memory. The application processor draws a simultaneous map of an environment where the cleaning robot 10 is located based on obstacle information fed back by the laser distance sensor by use of a localization algorithm, such as simultaneous localization and mapping. Based on distance information and speed information, which are fed back by the sensing devices (such as sensors disposed on the buffer 122, the cliff sensor, the magnetometer, the accelerometer, the gyroscope, and the odometer), a current working state, a current position, and a current posture of the cleaning robot 10 can be determined comprehensively, such as crossing a doorsill, encountering a carpet, arriving at a cliff, becoming stuck from above or below, having a full dust box, being picked up, etc. Also, a specific next-action strategy can be provided for different situations so that the cleaning robot 10 is able to provide a better cleaning performance and thus a better user experience.

As shown in FIG. 3, the driving system 140 may manipulate the robot body 110 to travel across the floor based on a driving command containing distance and angular information, such as x, y, and theta components. The driving system 140 includes the driving-wheel module 141, and the driving-wheel module 141 may control a left wheel and a right wheel simultaneously. In order to more precisely control the movement of the cleaning robot, the driving-wheel module 141 preferably includes a left driving-wheel module and a right driving-wheel module, respectively. The left driving-wheel module and the right driving-wheel module are disposed along a transverse axis defined by the robot body 110. In order to render the cleaning robot 10 to move along the floor more stably or raise itself for higher clearance, the cleaning robot 10 may include one or more driven wheels 142 which include, but are not limited to, universal wheels. The driving-wheel module 141 includes a walking wheel, a driving motor, and a control circuit for controlling the driving motor. The driving-wheel module 141 may also be connected to an odometer and a circuit for measuring a drive current. A driving wheel may also be provided with an offset drop type of suspension system, which is fastened movably to (e.g., attached rotatable to) the robot body 110, and receives a spring offset biased downward and away from the robot body 110. The spring offset allows the driving wheel to maintain contact and traction with respect to the floor by means of a certain floor-adhering force, while cleaning elements of the cleaning robot 100 are also in contact with the floor with a certain pressure.

The energy system 160 includes rechargeable batteries such as nickel hydrogen batteries and lithium batteries. The rechargeable battery may be connected to a charging control circuit, a battery pack charging temperature-detection circuit, and a battery undervoltage monitoring circuit. The charging control circuit, the battery pack charging temperature-detection circuit, and the battery undervoltage monitoring circuit are then connected to a microcontroller control circuit. A host is connected to a charging pile through a charging electrode disposed on a side of or below the robot body for the purpose of charging.

The human-computer interaction system 170 includes buttons on a panel of the host for a user to select functions. The human-computer interaction system 170 may also include a display screen and/or an indicator light and/or a horn, which present a current state or function options of the robot to the user. The human-computer interaction system 170 may also include a mobile client program. For a route-navigation type of automatic cleaning apparatus, a mobile client may present the user with a map of the environment where the apparatus is located as well as a location of the robot, which may provide the user with richer and more user-friendly function options.

The cleaning system 150 may be a dry cleaning system 151 and/or a wet cleaning system 153.

As shown in FIG. 3, the dry cleaning system 151 provided by the embodiments of the present disclosure may include a rolling brush, a dust box, a fan, and an air outlet. The rolling brush having a certain interference with the floor sweeps up debris on the floor and rolls the debris upward towards the front side of a dust-sucking port between the rolling brush and the dust box. Then the debris is sucked into the dust box by air which has a sucking force, is generated by the fan, and passes through the dust box. The dry cleaning system 151 may also include a side brush 152 having a rotation shaft angled relative to the floor for moving debris into a region of the rolling brush of the cleaning system 150.

As shown in FIGS. 3 and 4, the wet cleaning system 153 provided by the embodiments of the present disclosure may include a cleaning head 1531, a driving unit 1532, a water-delivery mechanism, a liquid storage tank, etc. The cleaning head 1531 may be disposed below the liquid storage tank, and the cleaning liquid inside the liquid storage tank is transported to the cleaning head 1531 by the water-delivery mechanism so that the cleaning head 1531 performs wet cleaning on a plane to be cleaned. In other embodiments of the present disclosure, the cleaning liquid inside the liquid storage tank may also be sprayed directly onto the plane to be cleaned, and the cleaning head 1531 achieves cleaning of the plane by evenly applying the cleaning liquid.

The cleaning head 1531 is configured to clean the surface to be cleaned. The driving unit 1532 is configured to drive the cleaning head 1531 to basically reciprocate along a target surface, and the target surface is a part of the surface to be cleaned. The cleaning head 1531 reciprocates along the surface to be cleaned. A surface of the cleaning head 1531 in contact with the surface to be cleaned is provided with a cleaning cloth or a cleaning plate, which generates a high-frequency friction with the surface to be cleaned through reciprocation, thereby removing stains on the surface to be cleaned.

Further, as shown in FIG. 5, the base station 20 includes a base station body 21, a washing assembly 30, and a liquid discharge device 35. The washing assembly 30 may be movably disposed on the base station body 21. Specifically, the washing assembly 30 can move relative to the base station body 21. For example, the washing assembly 30 can reciprocate along a horizontal direction of the base station 20. The horizontal direction of the base station 20 is indicated by a solid arrow in FIG. 5, and a direction indicated by a dashed arrow in FIG. 5 is a longitudinal direction of the base station 20. The washing assembly 30 includes a first washing component 31 and a second washing component 32 which are disposed side-by-side. The first washing component 31 and the second washing component 32 are configured to interfere with a cleaning system 150 of the cleaning robot 10 to remove debris on the cleaning system 150, thereby realizing cleaning of the cleaning system 150. It may be understood that the first washing component 31 and the second washing component 32 are different in structure and may be disposed side-by-side along a movement direction of the washing assembly 30 relative to the base station body 21.

That is, the washing assembly 30 faces the cleaning system 150 when the cleaning robot 10 moves to the base station body 21. By interfering with the cleaning system 150 of the cleaning robot 10, the first washing component and the second washing component remove the debris on the cleaning system 150 while the washing assembly 30 is moving relative to the base station body 21. Namely, the cleaning robot 10 may be automatically cleaned on the washing assembly 30 of the base station. This saves an operation for manual cleaning of the cleaning system 150 or the manual replacement of a new cleaning system 150, simplifies manual operations, enhances the manual cleaning experience, and thus is suitable for promotion and application.

Further, the washing assembly 30 may further include the liquid discharge device 35. While washing the cleaning system 150 of the cleaning robot 10 by the washing assembly 30, the liquid discharge device 35 of the washing assembly 30 works to spray a cleaning liquid onto the cleaning system 150 so that the cleaning system 150 is washed by means of an impact force of the cleaning liquid or the cleaning system 150 is wetted by the cleaning liquid, thereby improving the cleaning effect during cleaning of the cleaning system 150 by the first washing component 31 and the second washing component 32.

Further, the liquid discharge device 35 may also spray the cleaning liquid onto at least one of the first washing component 31 and the second washing component 32, so that the cleaning liquid is quickly and evenly applied to the cleaning system 150 through the first washing component 31 and/or the second washing component 32, thereby ensuring a good cleaning effect. It may be understood that the liquid discharge device 35 may also simultaneously spray the cleaning liquid onto the cleaning system 150, the first washing component, and/or the second washing component 32 to further improve the wetting efficiency of the cleaning system 150.

Specifically, the cleaning liquid sprayed as the liquid discharge device works is located at a side of the first washing component part 31 close to the second washing component 32.

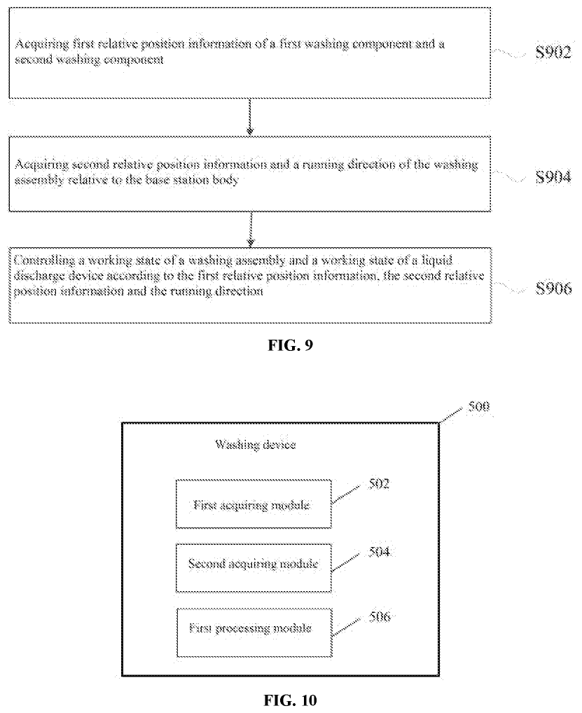

According to one of implementations of the present disclosure, as shown in FIG. 9, embodiments of the present disclosure provide a washing method. The washing method includes the following method steps.

In step S902, first relative position information of a first washing component and a second washing component is acquired.

In step S904, a running direction of a washing assembly relative to a base station body is acquired.

In some embodiments of the present disclosure, the first relative position information may be acquired according to a washing start instruction. The washing start instruction is configured to control the washing assembly 30 to start to move relative to the base station body 21 and/or control a liquid discharge device 35 to work for the purpose of washing a cleaning system 150 of a cleaning robot 10. When a base station 20 responds to the washing start instruction, it indicates that movement of a cleaning assembly is required so as to achieve cleaning of the cleaning system 150. It may be understood that the first relative position information and the running direction may also be acquired during running of the washing assembly 30.

The first relative position information is relative position information of the first washing component 31 and the second washing component 32. Specifically, the first washing component 31 and the second washing component 32 may be arranged side-by-side along a movement direction of the washing assembly 30 relative to the base station body 21. Since the first washing component 31 and the second washing component 32 are disposed at different positions, and the first washing component 31 may be located at a left and/or right side of the second washing component 32, the situation in which the first washing component 31 is located in the front and/or rear of the second washing component 32 in the movement direction may occur while the washing assembly 30 is moving in the same direction relative to the base station body 21. Meanwhile, different washing effects and different washing efficiency may occur due to different structures of the first washing component 31 and the second washing component 32. In addition, in this case, if the liquid discharge device 35 has been in operation, problems may arise that undermine the cleaning effect and waste resources.

The running direction is a running direction of the washing assemble 30 relative to the base station body 21. The different running directions of the washing assembly 30 relative to the base station body 21 affect the washing efficiency of the washing assembly 30. For example, when the washing assembly 30 is located between the left and right sides of the base station body 21 relative to the base station body 21, the washing assembly 30 may move to the right or left relative to the base station body 21. As the running directions of the washing assembly 30 relative to the base station body 21 may be different, the washing efficiency and the washing effect may also be different when the positions of the first washing component 31 and the second washing component 32 are fixed. In addition, in this case, if the liquid discharge device 35 has been in operation, problems may arise that undermine the cleaning effect and waste resources.

Specifically, the base station 20 includes a control device, and the first relative position information may be input through an input device, and thus the control device connected to the input device can determine the first relative position information. For example, when the structure of the washing assembly 30 is determined, the first relative position information of the first washing component 31 and the second washing component 32 is determined. For example, the first washing component 31 is located at the left and/or right side of the second washing component 32. This first relative position information is input in the input device, and thus the control device can acquire the first relative position information. It may be understood that the control device may also acquire the first relative position information via other devices that meet the requirements.

The running direction may be determined by a position switch, a sensing device 22, a signal transmission device, or a distance detection device connected to the control device, or by other devices that meet the requirements.

In step S906, a working state of the washing assembly and a working state of the liquid discharge device are controlled according to the first relative position information and the running direction.

While the washing assembly 30 is running in the same direction relative to the base station body 21, the different first relative position information may affect the cleaning effect and the washing efficiency of the washing assembly 30, waste resources, etc., and the different running directions may affect the positions of the first washing component 31 and the second washing component 32 in the running direction. Therefore, the washing assembly has the problems of reduced cleaning efficiency, poorer cleaning effect, and resource waste if the first relative position information and the running direction are not considered.

Therefore, in the present disclosure, the working state of the washing assembly 30 is controlled according to the first relative position information and the running direction so that the working state of the washing assembly 30 is calibrated to the first relative position information and the running direction, which helps improve the washing efficiency and the cleaning effect. Meanwhile, the working state of the liquid discharge device 35 is controlled to be calibrated to the first relative position information and the running direction. Ultimately, a liquid discharge state and the washing assembly 30 cooperate with each other, which helps to further improve the cleaning effect and reduce energy waste, thereby saving energy.

That is, according to the washing method provided by the present disclosure, the first relative position information of the first washing component 31 and the second washing component 32 is considered together with the running direction of the washing assembly 30 relative to the base station body 21, such that the working state of the washing assembly 30 is calibrated to the structure and the running direction of a cleaning assembly itself, and the working state of the liquid discharge device 35 is calibrated to the structure and the running direction of the cleaning assembly 30. Thus, not only the cleaning efficiency and the cleaning effect of the washing assembly 30 are improved, but also the energy utilization is improved, thereby saving energy and reducing the cleaning cost.

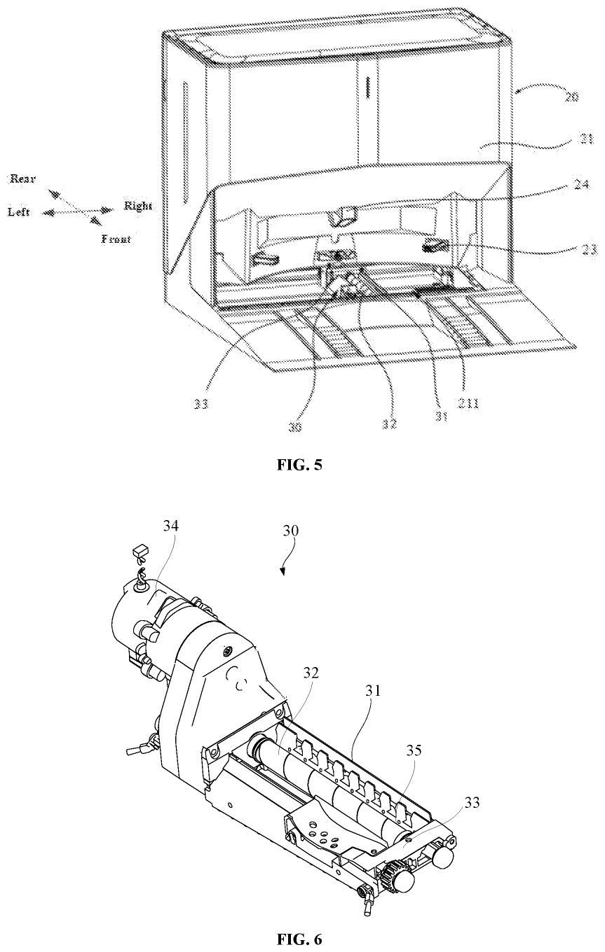

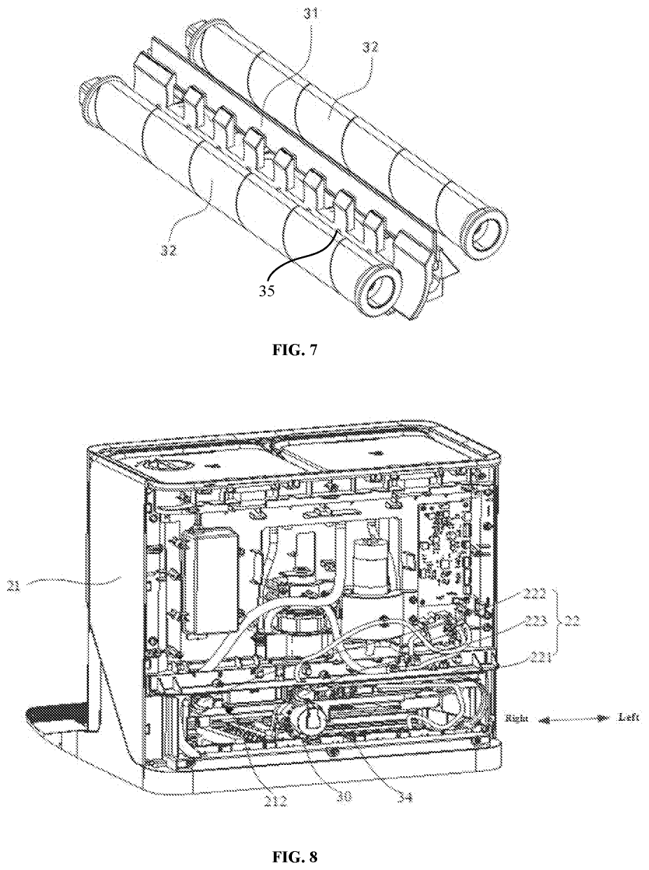

In the above embodiment, as shown in FIGS. 6 and 7, the first washing component 31 further includes a washing squeegee, and the second washing component 32 is rotatable around a rotation axis. That is, the second washing component 32 may rotate relative to the base station body 21. For example, the second washing assembly 30 includes a washing roller, which may rotate while moving horizontally with the washing assembly. Specifically, a brush and/or a vane is, are disposed on an outer surface of the ashing roller. The roller may be a soft rubber roller with a vane, or a brush with bristles on the outer surface. Specifically, the washing assembly 30 further includes a support 33 and a driving device 34. The first washing component 31 and the second washing component 32 are disposed on the support 33. The driving device 34 is configured to drive the support 33 to move relative to the base station body 21 and control the second washing component 32 to rotate.

A cleaning principle of the cleaning assembly is basically that the washing roller of the second washing component 32 may rotate, and the vanes or bristles of the roller may reach into the cleaning system of the cleaning robot 10 to take out the dirt hidden therein. In addition, as the washing assembly 30 moves horizontally, the squeegee of the first washing component 31 squeegees dirt and debris from the cleaning system, thereby achieving secondary cleaning of the wet cleaning assembly.

Specifically, during the cleaning process, the bristles or vanes of the second washing component 32 may reach into and be in sufficient contact with a cleaning head, and remove debris from the cleaning head of the wet cleaning system. Moreover, the second washing component 32 may rotate while moving horizontally, and the bristles or vanes thereof may pat the wet cleaning system during rotation, such that the debris hidden inside the cleaning system may be dislodged and squeegeed off under the vibration generated by the patting effect. Meanwhile, in cooperation with the operation of the second washing component 32, the squeegee of the first washing component 31 squeegees off the debris brought out or dislodged from the cleaning system, as well as the dirt to realize a washing operation of a washing system.

In some possible embodiments of the present disclosure, the step of controlling the working state of the washing assembly specifically includes:
controlling a rotation state of the second washing component.

In this embodiment, the rotation state of the second washing component 32 includes the start and stop of rotation of the second washing component 32. Further, the rotation state of the second washing component 32 may include a rotation direction. During movement of the washing assembly 30, the rotation of the second washing component 32 can remove the dirt hidden in the cleaning system 150, and the first washing component 31 can squeegee off the debris brought out or dislodged from the cleaning system 150 and also the dirt. Therefore, during running of the washing assembly 30, the first washing component 31 is located behind the second washing component 32 in the running direction, so that the first washing component 31 can squeegee off the debris brought out or dislodged from the cleaning system by the second washing component 32. Meanwhile, in cooperation with the liquid discharge device 35, which works to discharge the liquid to clean the cleaning system, the first washing component 31 can also squeegee off the dirty cleaning liquid generated after the washing operation on the cleaning system 150 is completed, thereby ensuring a good washing effect and a higher cleaning efficiency.

If, during the running of the washing assembly 30, the first washing component 31 is located in front of the second washing component 32 in a traveling direction, a phenomenon easily occurs in which the first washing component 31 cannot reliably squeegee off the debris brought out or dislodged by the second washing component 32 from the cleaning system 150. If the liquid discharge device 35 works to clean the cleaning system at this time, the first washing component 31 cannot squeegee off the dirty cleaning liquid from the cleaning system 150 in time, resulting in secondary soiling or energy waste.

In view of this, in the present disclosure, the first relative position information of the first washing component 31 and the second washing component 32 is reasonably considered together with the running direction of the washing assembly 30 relative to the base station body 21, so that the rotation state of the second washing component 32 is controlled and is calibrated to the working state of the liquid discharge device 35. Thus, the first washing component 31 can reliably and effectively squeegee off the debris brought out or dislodged from the cleaning system 150 by the second washing component 32, and meanwhile squeegee off the dirty cleaning liquid which is generated after the washing operation on the cleaning system 150 is completed. This helps to further improve the washing effect and the washing efficiency, and avoids secondary pollution or energy waste caused by the inability of the first washing component 31 to squeegee off the dirty cleaning liquid in time. Thus, the cleaning effect is greatly improved and the energy utilization improves, thereby saving energy and reducing the cost of cleaning.

In some possible embodiments provided by the present disclosure, the first relative position information includes first position information and second position information. The first position information indicates that the first washing component 31 is located at one side of the second washing component 32, for example as shown in FIG. 6, along the movement direction of the washing assembly 30. For example, when the movement direction is a horizontal direction of the base station 20, the first washing component 31 is disposed at the left or right side of the second washing component 32. The second position information indicates that at least two second washing components 32 are arranged at two sides of the first washing component 31 along the movement direction of the washing assembly 30. As shown in FIG. 7, the second washing components 32 are disposed at two sides of the first washing component 31 respectively. It may be understood that the number of second washing components 32 located at two sides of the first washing component 31 may be the same or different.

Step S906 of the washing method includes the following details.

In step S906-1, when the second washing component is located in front of the first washing component in the movement direction of the washing assembly, the second washing component is controlled to rotate, and the liquid discharge device is controlled to work.

In this embodiment, when the second washing component 32 is located in front of the first washing component 31 in the movement direction of the washing assembly 30, it indicates that during the movement of the washing assembly 30 relative to the base station body 21, the first washing component 31 can squeegee off the dirt brought out from the cleaning system 150 by the second washing component 32. It may be understood that at the same time, the liquid discharge device is controlled to work, so that the first washing component 31 can squeegee off the cleaning liquid, which is sprayed as the liquid discharge device 35 works, after the cleaning operation of the washing system is completed. Therefore, in this case the second washing component 32 is controlled to rotate and the liquid discharge device 35 is controlled to work, which can improve the washing efficiency and ensure a good washing effect.

Further, in some embodiments provided by the present disclosure, the liquid discharge device 35 sprays the cleaning liquid onto the rotating second washing component 32, and the rotation of the second washing component 32 can evenly apply the cleaning liquid onto the cleaning system of the cleaning robot, which helps to improve the cleaning effect of the cleaning system and increasing the utilization of the cleaning liquid. It may be understood that in other embodiments of the present disclosure, the liquid sprayed as the liquid discharge device 35 works can directly act on the cleaning system of the cleaning robot. At this time, in cooperation with the rotation of the second washing component 32, the cleaning effect of the cleaning system can also be improved.

It may be understood that, if the first washing component 31 is located in front of the second washing component 32 in the running direction of the washing assembly 30, in one example, with respect to the rotation of the second washing component 32, the second washing component 32 may be controlled to rotate so that the dirt hidden in the cleaning system 150 is removed. It may be understood that at this time, since the first washing component 31 is located in front of the second washing component 32 in a traveling direction of the washing assembly 30, the first washing component 31 cannot remove the dirt brought out by the second washing component 32 from the cleaning system 150 in time. However, during the reverse travelling of the washing assembly 30 relative to the base station body 21, when the first washing component 31 is located behind the second washing component 32, the dirt on the cleaning system 150 can be reliably and effectively squeegeed off. In other words, such a solution achieves the effect of having the second washing component 32 remove dirt from the cleaning system 150 in advance, which helps to improve the cleaning effect and the cleaning efficiency.

In another example, it is possible to control the second washing component 32 not to rotate. This arrangement helps to reducing the energy consumption of a driving system of the cleaning assembly. The driving system is configured to drive the second washing component 32 to rotate relative to the base station body 21, which reduces cleaning cost.

In the above embodiment, the liquid discharge device is disposed side-by-side with the first washing component and the second washing component.

The step of controlling the liquid discharge device to work includes:
controlling the liquid discharge device, which is in front of the first washing component in the movement direction, to work.

In this embodiment, by disposing the liquid discharge device 35 side-by-side with the first washing component 31 and the second washing component 32, it can be ensured that the liquid sprayed by the liquid discharge device 35 mostly acts on the cleaning system 150 of the cleaning robot 10, which helps to increasing the utilization of the liquid in the liquid discharge device 35. As the liquid discharge device 35 is disposed at different positions, for example, the liquid discharge device 35 is located behind the first washing component 31 in the running direction of the washing assembly 30, the situation may occur that the first washing component 31 cannot squeegee off the dirty cleaning liquid in time, thereby resulting in secondary pollution or energy waste. Therefore, in the present disclosure, by controlling the liquid discharge device 35, which is in front of the first washing component 31 in the movement direction, to work, the first washing component 31 can squeegee off the dirty cleaning liquid in time which is generated after the washing operation on the cleaning system is completed, during operation of the washing assembly relative to the base station body. This avoids the problems of resource waste and pollution, and helps to improve the washing effect and the washing efficiency.

It may be understood that nozzles of the liquid discharge device 35 may be arranged along the movement direction of the washing assembly 30. That is, the liquid sprayed by the nozzles of the liquid discharge device 35 may be located on two sides of the first washing component 31. By reasonably controlling a working state of the nozzles of the liquid discharge device 35, the nozzles of the liquid discharge device 35 located behind the first washing component 31 in the running direction of the washing assembly 30 are controlled to cease operation, in order to save energy and improve the cleaning effect. Also, the nozzles of the liquid discharge device located in front of the first washing component 31 in the movement direction of the washing assembly 30 are controlled to work to ensure a good washing effect.

In some possible embodiments provided by the present disclosure, the washing method may further include the following steps.

In step S901-1, second relative position information of the washing assembly and the base station body are acquired.

In step S901-2, an initial running direction of the washing assembly is controlled according to the second relative position information.

In this embodiment, the second relative position information is position information of the washing assembly 30 relative to the base station body 21. Since in an initial state the washing assembly 30 may be located at one side, at a middle position, or near one side of the base station body 21, when the washing assembly 30 initially runs in a different direction relative to the base station body 21, a situation may occur where the time for the washing assembly 30 to reach one side of the base station body 21 changes. That is, after running in an initial direction for a specified time, the washing assembly 30 needs to switch direction. However, each change of direction causes the washing assembly 30 to consume a lot of power. Therefore, by controlling the initial running direction of the washing assembly 30 according to the second relative position information, the initial running direction of the washing assembly 30 relative to the base station body 21 is related to the second relative position information of the washing assembly 30 and the base station body 21 in the initial state, so that the time that the washing assembly 30 requires for the first direction switch can be adjusted, which reduces the energy consumption and cost of operation.

In above embodiments, the washing method further includes the following steps.

It is determined whether a distance between the washing assembly and a first side edge of the base station body is greater than or equal to a distance between the washing assembly and a second side edge of the base station body.

The washing assembly is controlled to move in the direction of the first side edge of the base station body when the distance between the washing assembly and the first side edge of the base station body is greater than or equal to the distance between the washing assembly and the second side edge of the base station body.

In this embodiment, along the running direction of the washing assembly 30, the base station body 21 is provided with the first side edge and the second side edge, which are opposite one another. If the running direction of the washing assembly 30 is the horizontal direction of the base station, the first side edge may be located on the left side of the base station and the second side edge may be located on the right side of the base station. Alternately, the first side edge is located on the right side of the base station and the second side edge is located on the left side of the base station.

In the initial state, it is determined whether the distance between the washing assembly 30 and the first side edge of the base station body 21 is greater than or equal to the distance between the washing assembly 30 and the second side edge of the base station body 21. Since the distance between the washing assembly 30 and the first side edge of the base station body 21 is different from the distance between the washing assembly 30 and the second side edge of base station body 21, it takes different running time for the washing assembly 30 to reach the first and second side edges and perform a turning operation. Therefore, when it is determined that the distance between the cleaning assembly and the first side edge of the base station body 21 is greater than or equal to the distance between the washing assembly 30 and the second side edge of the base station body 21, it indicates that the time spent by the washing assembly 30 moving in the direction of the first side edge and reaching the first side edge is greater than or equal to the time spent by the washing assembly 30 moving in the direction of the second side edge and reaching the second side edge. At this time, the washing assembly 30 is controlled to move in the direction of the first side edge of the base station body 21 so that it takes a longer time or set time for the washing assembly 30 to reach the first side edge of the base station body 20. Thus, the problem can be alleviated of the washing assembly 30 first running for a shorter time to reach the second side edge and then turning around, which reduces energy consumption.

That is to say, in the washing method provided by the present disclosure, the initial running direction of the washing assembly 30 indicates that the washing assembly 30 moves in the direction of the first side edge of the base station body 21. When the washing assembly 30 first runs relative to the base station body 21, the washing assembly 30 is controlled to move in the direction of the first side edge being spaced by a further distance or set distance from the washing assembly 30. Thus, it takes a longer time or set time for the washing assembly 30 to reach the first side edge of the base station body 21 and then turn around, which reduces energy consumption and improves energy utilization.

Further, the base station is provided with a distance detection device. The distance detection device may be disposed on the base station body 21 and/or the washing assembly 30. The different disposed positions of the distance detection device can meet the requirements for different structures of the distance detection device. Specifically, the distance detection device may be a distance sensor, a distance detection switch, etc.

In some possible embodiments provided by the present disclosure, the washing method further includes:
after the washing assembly 30 arrives at the first side edge of the base station body 21, controlling the washing assembly 30 to move in the direction of the second side edge of the base station body 21.

In this embodiment, after running and arriving at the first side edge along the initial running direction, the washing assembly reverses direction and moves in the direction of the second side edge of the base station body 21. That is, the washing assembly 30 reciprocates relative to the base station body 21. The reciprocation indicates that the washing assembly 30 moves from the first side edge of the base station body 21 to the second side edge of the base station body 21, and then returns from the second side edge of the base station body 21 to the first side edge of the base station body 21, and this process is repeated. The washing assembly 30 is controlled to reciprocate relative to the base station body 21, which aids in the thorough and effective cleaning of the cleaning system 150 of the cleaning robot 10 by the washing assembly 30, thereby improving the cleaning effect of the washing system and bolstering user satisfaction.

In some possible embodiments of the present disclosure, the washing method further includes the following step.

In step S908, the washing assembly is controlled to move in the direction of and arrive at a second preset position of the base station body in response to a washing end instruction.

The washing end instruction is configured to control the washing assembly 30 to cease the washing operation. When the base station 20 responds to the washing end instruction, it indicates that, at this time, movement of the washing assembly 30 is not required to clean the cleaning system 150. The preset position may be a position of the base station body 21 near the first side edge or near the second side edge. At this time, the preset position may be either the first side edge of the base station body 21 or the second side edge of the base station body 21. Alternatively, the preset position may be a position near the middle of the base station body 21. That is, the preset position is located between the first and second side edges of the base station body 21.

By causing the cleaning assembly to move in the direction of and arrive at the preset position of the base station body 21 in response to the washing end instruction, that is, when the washing assembly 30 does not need to perform a cleaning operation, the washing assembly 30 neither blocks nor interferes with other components of the cleaning robot 10, nor does it shield or interfere with other components of the base station. This creates an occasion for the cleaning robot 10 to perform other operations on the base station, such as a charging operation or an operation for replenishing the cleaning liquid, or another operation.

In response to the washing end instruction, the second washing component 32 may also be controlled to stop rotating, i.e., to stop using the second washing component 32 to remove debris from the cleaning system 150, which reduces the energy consumption of the driving system. The liquid discharge device 35 is controlled to cease operation, i.e., to stop using the cleaning liquid sprayed by the liquid discharge device 35 to clean the cleaning system 150, which saves energy and reduces energy consumption. Meanwhile, the washing assembly 30 is controlled to move to the preset position of the base station body 21 so as to stop the cleaning operation on the cleaning system 150. It may be understood that the control device may also control the second washing component 32 to stop rotating and control the liquid discharge device 35 to cease operation when the washing assembly 30 moves to the preset position of the base station body 21.

Specifically, the preset position is a middle position of the base station body 21. For example, the preset position is a middle position between the first and second side edges of the base station body 21. That is, when the washing assembly 30 completes the cleaning operation on the cleaning system 150 of the cleaning robot 10, the base station controls the washing assembly 30 to move to the middle position of the base station body 21 in response to the cleaning end instruction.

Specifically, while washing the cleaning system 150 of the cleaning robot 10, it is possible to repeat the steps that, after the washing assembly arrives at the first side edge of the base station body, the washing assembly is controlled to move in the direction of the second side edge of the base station body; and after the washing assembly arrives at the second side edge of the base station body, the washing assembly is controlled to return to the first side edge of the base station body, so as to increase the washing intensity for the cleaning system 150 and ensure a good cleaning effect. For example, the working time of the washing assembly 30 may be preset, and when the preset working time elapses, the washing process ends. A sensor may also be disposed on the base station 20 or the cleaning robot 10 to detect the degree of dirtiness of the cleaning system 150. When data output by the sensor shows that the degree of dirtiness of the cleaning system 150 of the cleaning robot 10 is lower than a predetermined threshold, the cleaning process ends.

In some possible embodiments of the present disclosure, step S901-1 includes:
acquiring a second relative position relationship between the washing assembly and the base station body via a sensing device and a signal transmission device, which are disposed on the base station body and the washing assembly, respectively.

In this embodiment, as shown in FIG. 8, the base station 20 further includes the sensing device 22 and the signal transmission device. The second relative position relationship of the washing assembly 30 vis-A-vis the base station body 21 is determined via the sensing device 22 and the signal transmission device. For example, it is determined whether the washing assembly 30 moves and arrives at the first side edge, the second side edge, or the preset position of the base station body 21 relative to the base station body 21, which helps to control the running direction of the washing assembly 30 relative to the base station body 21, as well as control the working states of the second washing component 32 and the liquid discharge device 35. This is conducive to improving the control accuracy over the washing assembly 30 and the liquid discharge device 35, improving the cleaning effect, and saving energy.

Further, on the one hand, the sensing device 22 is disposed on the base station body 21, and the signal transmission device is disposed on the washing assembly 30. On the other hand, the sensing device 22 is disposed on the washing assembly 30, and the signal transmission device is disposed on the base station body 21. The different disposition positions of the sensing device 22 and the signal transmission device can meet the demands for different structures of the sensing device 22 and of the signal transmission device, which expands the application range of the product.

Specifically, the sensing device 22 includes at least one of an optical coupling element, a magnetic induction element, and a microswitch. It may be understood that the signal transmission device is a trigger element adapted to the sensing device 22, such as an optical transmission device adapted to the optical coupling element, a magnetic signal transmission device adapted to the magnetic induction element, or a movable structure adapted to the microswitch.

In the above embodiment, a first sensing device 221 is disposed near the first side edge of the base station body 21, a second sensing device 222 is disposed near the second side edge of the base station body 21, and a third sensing device 223 is disposed near the preset position of the base station body 21.

The step of acquiring the second relative position relationship between the washing assembly and the base station body via the sensing device and the signal transmission device, which are disposed on the base station body 21 and the washing assembly 30, respectively, includes:
determining that the washing assembly arrives at the first side edge of the base station body when the signal transmission device is detected by the first sensing device;
determining that the washing assembly arrives at the second side edge of the base station body when the signal transmission device is detected by the second sensing device; and
determining that the washing assembly arrives at the preset position of the base station body when the signal transmission device is detected by the third sensing device.

That is to say, in an embodiment of the present disclosure, the sensing device 22 is disposed on the base station body 21, the signal transmission device is disposed on the washing assembly 30, and three sensing devices 22 are disposed, including the first sensing device 221 (disposed near the first side edge of the base station body 21), the second sensing device 222 (disposed near the second side edge of the base station body 21), and the third sensing device 223 (disposed near the preset position of the base station body 21). Along the running direction of the washing assembly 30, the preset position of the base station body 21 is a middle position between the first and second side edges of the base station body 21. That is, along the running direction of the washing assembly 30, the third sensing device is disposed at a middle position of the base station body.

With such an arrangement, in the process in which the washing assembly 30 runs relative to the base station body 21, if the first sensing device 221 detects the signal transmission device, it indicates that the washing assembly 30 arrives at the first side edge of the base station body 21 relative to the base station body 21. The control device may control the washing assembly to move in the direction of the second side edge of the base station body 21 according to the detected information. If the second sensing device 222 detects the signal transmission device, it indicates the arrival of the washing assembly 30 at the second side edge of the base station body 21 relative to the base station body 21. The control device may control the washing assembly 30 to move in the direction of the first side edge of the base station body 21 according to the detected information. If the third sensing device 223 detects the signal transmission device, it indicates the arrival of the washing assembly 30 at the preset position of the base station body 21 relative to the base station body 21. The control device may control the second washing component 32 of the washing assembly 30 to stop rotating and also control the liquid discharge device 35 to cease operation according to the detected information. With such an arrangement, a simple structure and a sensitive and accurate detection are achieved, which helps to improve the control accuracy of the washing method.

In a specific example of the present disclosure, the case where the first side edge of the base station body 21 is located on the left side of the second side edge of the base station body is taken as an example. When the cleaning robot 10 is parked at the base station 20, the control device of the base station 20 firstly determines whether the distance between the washing assembly 30 and the first side edge of the base station body is greater than or equal to the distance between the washing assembly and the second side edge of the base station body by means of the distance detection device, controls the washing assembly to move in the direction of the first side edge of the base station body if the above determination is positive; and controls the washing assembly to move in the direction of the second side edge of the base station body if the above determination is negative.

If the first sensing device 221 detects the signal transmission device, it indicates the arrival of the washing assembly 30 at the first side edge of the base station body 21 relative to the base station body 21, and the control device may control the washing assembly to move in the direction of the second side edge of the base station body 21 according to the detected information. If the second sensing device 222 detects the signal transmission device, it indicates the arrival of the washing assembly 30 at the second side edge of the base station body 21 relative to the base station body 21, and the control device may control the washing assembly to move in the direction of the first side edge of the base station body 21 according to the detected information. It may be understood that the washing assembly 30 may reciprocate multiple times during this process until the washing work is completed.

In a specific example, the case where the first washing component 31 is located at the left side of the second washing component 32 and the liquid discharge device is located at the right side of the first washing component 31 is taken as an example. When the second washing component 32 is located in front of the first washing component 31 in the running direction of the washing assembly 30, the second washing component 32 is controlled to rotate, and the liquid discharge device 35 is controlled to work. That is, when the washing assembly 30 runs from the first side edge to the second side edge of the base station body 21, i.e., when the washing assembly 30 move in the direction of the right side, the second washing component 32 is located in front of the first washing component 31 in the movement direction, and the liquid discharge device 35 is located in front of the first washing component 31. At this time, the second washing component 32 is controlled to rotate and the liquid discharge device 35 located in front of the first washing component 31 is controlled to work, so that the rotating second washing component 32 remove the dirt from the cleaning system 150, and the liquid sprayed by the liquid discharge device 35 can act on the cleaning system 150 to implement a cleaning operation. Alternatively, the liquid discharge device 35 is evenly applied to the cleaning system via the rotating second washing component 32. In addition, in the process in which the washing assembly 30 runs from the first side edge to the second side edge, the first washing component 31 located behind the rotating second washing component 32 may squeegee off the dirt brought out of the cleaning system 150 by the rotating second washing component 32. At the same time, the dirty cleaning liquid, which is generated after the cleaning operation of the washing system is completed, can be squeegeed off; thereby ensuring a good cleaning effect of the washing system.

Further, when the washing assembly 30 runs from the second side edge to the first side edge of the base station body 21, that is, when the washing assembly 30 moves in the direction of the left side, the second washing component 32 is located behind the first washing component 31 in the movement direction, and the liquid discharge device 35 is located behind the first washing component 31. At this time, the second washing component 32 is controlled to rotate or not rotate, and the liquid discharge device is controlled to cease working.

In another example, along the movement direction of the washing assembly 30, at least two second washing components 32 are arranged at two sides of the first washing components 31. For example, the second washing components 32 are disposed at the left and right sides of the first washing component 31. It may be understood that the numbers of the second washing components 32 located at the left and right sides of the first washing component 31 may be the same or different. The liquid discharge device 35 may also be arranged at two sides of the first washing component.

When the washing assembly 30 runs from the first side edge to the second side edge of the base station body 21, that is, when the washing assembly 30 moves in the direction of the right side, the second washing component 32 located at the right side of the first washing component 31 and the liquid discharge device 35 located at the right side of the first washing component 31 are both located in front of the first washing component 31 in the movement direction. At this time, the second washing component 32 located at the right side of the first washing component 31 is controlled to rotate and the liquid discharge device 35 located at the right side of the first washing component 31 is controlled to work, so that the rotating second washing component 32 can remove the dirt from the cleaning system 150, and the liquid sprayed by the liquid discharge device 35 can act on the cleaning system to implement the cleaning operation. Alternatively, the liquid discharge device 35 is evenly applied to the cleaning system via the rotating second washing component 32. In addition, in the process in which the washing assembly 30 runs from the first side edge to the second side edge, the first washing component 31 located behind the rotating second washing component 32 may squeegee off the dirt brought out of the cleaning system by the rotating second washing component 32. In the meanwhile, the dirty cleaning liquid, which is generated after the cleaning operation of the washing system is completed, can be squeegeed off, thereby ensuring a good cleaning effect.

Further, when the washing assembly 30 runs from the second side edge to the first side edge of the base station body, that is, when the washing assembly 30 moves in the direction of the left side, the second washing component 32 located at the left side of the first washing component 31 and the liquid discharge device 35 located at the left side of the first washing component 31 are both positioned in front of the first washing component 31 in the movement direction. At this time, the second washing component 32 located at the left side of the first washing component 31 is controlled to rotate and the liquid discharge device 35 located at the left side of the first washing component 31 is controlled to work, so that the first washing component 31 located behind the rotating second washing component 32 can also squeegee off the dirt brought out of the cleaning system by the rotating second washing component 32, and in the meanwhile, squeegee off the dirty cleaning liquid generated after the cleaning operation of the washing system is completed, thereby ensuring a good cleaning effect.

Further, in the above embodiment, during the running process of the washing assembly, if the control device receives a washing end instruction, it controls the washing assembly 30 to continue running. If the third sensing device detects the signal transmission device, it indicates that the washing assembly 30 moves relative to the base station body 21 and arrives at the preset position of the base station body 21. The control device may control the second washing component 32 of the washing assembly to stop rotating and also control the liquid discharge device 35 to cease operation according to the detected information so as to end the washing work.

For example, the working time of the washing assembly 30 may be preset, and when the preset working time elapses, the washing process ends. A sensor may also be disposed on the base station 20 or the cleaning robot 10 to detect the degree of dirtiness of the cleaning system 150. When data output by the sensor shows that the degree of dirtiness of the cleaning system 150 of the cleaning robot 10 is under a predetermined threshold, the cleaning process ends. As shown in FIG. 8, the base station body 21 is provided with a mounting groove 212, and the sensing device 22 is disposed in the mounting groove 212. The arrangement of the mounting groove 212 protects the sensing device 22 to some extent, and helps to reduce pollution to the sensing device 22 by the dirt and debris, thereby helping to prolong service life and improving sensitivity of the sensing device 22, as well as improving the control accuracy and reliability of the base station 20.

Further, the sensing device 22 is detachably connected to the mounting groove 212. If a slot is formed inside the mounting groove 212 and the sensing device 22 is provided with a snap, the cooperation between the slot and the snap allow the sensing device 22 to be quickly and accurately mounted in the mounting groove 212 of the base station body 21. Alternatively, the mounting groove 212 is internally provided with a threaded hole, and the sensing device 22 is provided with a through hole. A bolt passes through the through hole and is connected to the threaded hole, so that the sensing device 22 can be detachably mounted in the mounting groove 212.

The sensing device 22 is detachably connected to the mounting groove 212 so that the sensing device 22 can be detached from the mounting groove 212 for maintenance or replacement. This is convenient to operate and reduces maintenance and replacement costs.

Further, the washing assembly 30 is provided with a mounting part. For example, the mounting part is disposed on the support 33. The signal transmission device is disposed on the mounting part, and the mounting part faces the sensing device 22. The arrangement of the mounting part is conducive to improving the reliability of the connection between the signal transmission device and the support 33. Mean ile, the arrangement of the mounting part is conducive to pre-locating the signal device, so that the height of the signal device located on the washing assembly 30 is calibrated to the height of the sensing device 22 on the base station body 21 to improve the sensing accuracy of the sensing device 22. In addition, the signal transmission device is disposed to face the sensing device 22, which helps to further improve the sensing accuracy and sensitivity of the sensing device 22, and improving the control accuracy and reliability of the base station 20.

Specifically, the mounting part is provided with a slot, and the signal transmission device is provided with a snap. Through the cooperation between the slot and the snap, the signal transmission device is mounted on the washing assembly 30, or the signal transmission device is directly clamped inside the slot. Thus, a simple structure and ease in mounting are achieved. It may be understood that the signal transmission device may also be mounted on the washing assembly 30 through bolts or other types of hardware that meet the requirements.

The signal transmission device is detachably connected to the mounting part of the support 33, so that the signal transmission device can be detached from the mounting part of the washing assembly 30 for maintenance or replacement, which is convenient to operate and reduces maintenance and replacement costs.

Further, as shown in FIGS. 5 and 8, the sensing device 22 is disposed behind the base station body 21. In general, the base station 20 further includes a charging contact 23 for being connected to the cleaning robot 10 for supplying power. The charging contact 23 is disposed in front of the base station body 21, which facilitates connection with the cleaning robot 10. By disposing the sensing device 22 behind the base station body 21, there is a sufficient space in front of the base station body 21 for arrangement of the charging contact 23 or other components that match the cleaning robot 10, thereby achieving a reasonable layout of the base station 20 and facilitating the function expansion of the base station 20.

For example, to enable the washing robot to be reliably and accurately parked on the base station 20, a guide part 24, such as a guide pressing block or a guide wheel, is usually disposed on the front of the base station body 21. The contact between the guide part 24 and the cleaning robot 10 can guide the movement of the cleaning robot 10 towards the frame of the base station 20, and can limit the vertical movement of the cleaning robot 10. This helps to improve the smoothness and accuracy in parking the cleaning robot 10 on the frame of the base station 20, and to improve the efficiency in parking the robot on the frame of the base station 20, thereby being suitable for promotion and application.

In the present disclosure, the sensing device 22 is disposed behind the base station body 21, so that the arrangement of the guiding part 24 is not affected and thus the reliability and accuracy in parking the cleaning robot 10 on the base station 20 can be ensured.

As shown in FIGS. 6 and 8, the washing assembly 30 further includes a driving device 34 for driving the support 33 to move relative to the base station body 21. The signal transmission device is disposed on the driving device 34. It may be understood that the signal transmission device may be disposed on a part of the driving device 34 extending to the rear of the base station body 21. This arrangement can shorten the distance between the sensing device 22 and the signal transmission device, which helps to improve the induction sensitivity and reliability of the sensing device 22, and as such enhances the control accuracy of the base station 20. In some possible embodiments provided by the present disclosure, the first relative position information includes second position information. The second position information indicates that at least two second washing components 32 are arranged at two sides of the first washing component 31 along the movement direction of the washing assembly 30. As shown in FIG. 7, the second washing components 32 are disposed at the left and right sides of the first washing component 31. It may be understood that the numbers of the second washing components 32 located at the left and right sides of the first washing component 31 may be the same or different. Specifically, step S904 of the washing method may include the following details.

In some possible embodiments provided by the present disclosure, as shown in FIG. 5, the base station 20 further includes a cleaning tank 211 located below the washing assembly 30. The cleaning tank 211 is configured to accommodate the debris removed from the cleaning system of the cleaning robot 10 by the washing assembly 30, and/or to collect the dirt generated during the cleaning process of the cleaning system, thereby facilitating subsequent treatment of the debris and dirt as well as improving the cleanliness of the environment near the base station 20. The dirt is formed after the cleaning system is cleaned by the cleaning liquid sprayed by the liquid discharge device 35.

Further, a dirt outlet is formed in at least one side of the cleaning tank 211, and the debris in the cleaning tank 211 can be removed from the cleaning tank 211 through the dirt outlet.

The dirt outlet may be formed in one or two sides of the cleaning tank 211, and different positions of the dirt outlet can meet the demands for different structures of the cleaning tank 211, which expands the application range of the product. It may be understood that one, two, or more dirt outlets may also be formed in the same side of the cleaning tank 211.

The base station 20 further includes a liquid-level detection device, which may be a liquid-level sensor, a liquid-level float, or other structures that meet the requirements. The liquid-level detection device is configured to detect a level of the liquid in the cleaning tank 211.

The washing method provided by the present disclosure further includes the following steps.

In step S910, information on the liquid level in the cleaning tank is acquired, and the working state of the liquid discharge device is controlled based on the information obtained on the liquid level.

In this embodiment, the information obtained on the liquid level in the cleaning tank 211 can indicate the level of the liquid contained in the cleaning tank 211. When the liquid level reaches a preset threshold, it indicates that the level of the liquid in the cleaning tank 211 is high, and a situation arises in which the normal working of the washing assembly or the base station is affected. Therefore, the liquid discharge device 35 is controlled to cease operation, so as avoid the situation that the liquid discharge device 35 continues working to increase the level of the liquid in the cleaning tank 211, which otherwise causes the dirt to overflow the cleaning tank 211 and gives rise to secondary pollution, or causes the dirt to affect the normal working of the washing assembly 30 or the base station. This helps to improve the cleanliness of the environment near the base station 20 and the working reliability of the base station 20.

When the liquid level does not reach the preset threshold, it indicates that the cleaning tank 211 may still accommodate the dirt. Therefore, the liquid discharge device 35 is controlled to continue maintaining its current working state, and a situation in which the dirt inside the cleaning tank 211 overflows the cleaning tank 211 is circumvented.

The preset threshold may be less than the height of the cleaning tank 211. Specifically, the preset threshold may be a fixed value, such as 20 mm, 30 mm, 40 mm, or other values that meet the requirements. Alternatively, the preset threshold matches the height of the cleaning tank 211. For example, the preset threshold is 0.95 times, 0.9 times, 0.85 times the height of the cleaning tank 211, or other values that meet the requirements, which is not limited in the present disclosure.

As shown in FIG. 10, embodiments according to a second aspect of the present disclosure provide a washing device 500 for a base station to be used cooperatively with a cleaning robot. The base station includes a base station body, a washing assembly, and a liquid discharge device. The washing assembly is movably disposed on the base station body, and includes a first washing component and a second washing component, which are disposed side-by-side and configured to interfere with a cleaning system of the cleaning robot to remove debris on the cleaning system. The cleaning liquid discharged from the liquid discharge device is configured to wash the cleaning system.

The washing device 500 includes:
a first acquiring module 502, configured to acquire first relative position information of the first washing component and the second washing component;
a second acquiring module 504, configured to acquire a running direction of the washing assembly relative to the base station body; and
a first processing module 506, configured to control a working state of the washing assembly and a working state of the liquid discharge device according to the first relative position information and the running direction.

According to the washing device 500 provided by the present disclosure, the first acquiring module 502 acquires the first relative position information, the second acquiring module acquires the running direction of the washing assembly relative to the base station body, and the first processing module 506 controls the working state of the washing assembly, so that the working state of the washing assembly is calibrated to the first relative position information and the running direction, which helps to improve the washing efficiency and the cleaning effect. Meanwhile, the working state of the liquid discharge device is controlled to be calibrated to the first relative position information and the running direction. Ultimately, a liquid discharge state and the washing assembly cooperate with each other in a complementary way, which aids in improving the cleaning effect and reducing the energy waste, thereby increasing energy utilization and saving energy.

That is, in the washing device 500 according to the present disclosure, the first relative position information of the first washing component and the second washing component are considered comprehensively together with the running direction of the washing assembly relative to the base station body, so that the working state of the washing assembly is calibrated to the structure and the running direction of the cleaning assembly itself, and the working state of the liquid discharge device is calibrated to the structure and the working state of the cleaning assembly. Thus, not only the cleaning efficiency and the cleaning effects of the washing assembly are improved, but also the energy utilization is improved, thereby saving energy and reducing the cleaning cost.

As an example, the first washing component includes a washing squeegee, and the second washing component is rotatable around a rotation axis. The first processing module 506 includes a first processing unit configured to control a rotation state of the second washing component.

As an example, the first processing module 506 includes a second processing unit configured to: when the second washing component is located in front of the first washing component in a movement direction of the washing assembly, control the second washing component to rotate, and control the liquid discharge device to work.

As an example, the liquid discharge device is disposed side-by-side with the first washing component and the second washing component, and the liquid discharge device is controlled to work. The second processing unit includes a first processing sub-unit configured to control the liquid discharge device to work, where the liquid discharge device is located in front of the first washing component in the movement direction.

As an example, the washing device further includes:
a third acquiring module, configured to acquire second relative position information of the washing assembly and base station body, and
a second processing module, configured to control an initial running direction of the washing assembly according to the second relative position information.

As an example, the washing device further includes:
a detection module, configured to determine whether a distance between the washing assembly and a first side edge of the base station body is greater than or equal to a distance between the washing assembly and a second side edge of the base station body; and
a second processing module, which includes a second processing sub-unit configured to control the washing assembly to move in the direction of the first side edge of the base station body, when the distance between the washing assembly and the first side edge of the base station body is greater than or equal to the distance between the washing assembly and the second side edge of the base station body.

As an example, the second processing module further includes a third processing sub-unit configured to, after the washing assembly arrives at the first side edge of the base station body, control the washing assembly to move in the direction of the second side edge of the base station body and control the liquid discharge device to cease operation.

As an example, the washing apparatus further includes: a third processing module configured to control the washing assembly to move in the direction of and arrive at a preset position of the base station body in response to a washing end instruction.

As an example, the third acquiring module acquires a second relative position relationship between the washing assembly and the base station body via a sensing device and a signal transmission device which are, respectively, disposed on the base station body and the washing assembly.

As an example, a first sensing device is disposed near the first side edge of the base station body, a second sensing device is disposed near the second side edge of the base station body, and a third sensing device is disposed near the preset position of the base station body.

The third acquiring module includes:
a first determining unit, configured to determine that the washing assembly arrives at the first side edge of the base station body when the signal transmission device is detected by the first sensing device;
a second determining unit, configured to determine that the washing assembly arrives at the second side edge of the base station body when the signal transmission device is detected by the second sensing device; and
a third determining unit, configured to determine that the washing assembly arrives at the preset position of the base station body when the signal transmission device is detected by the third sensing device.

As an example, the base station further includes a cleaning tank located below the washing assembly.

The washing device further includes:
a fourth acquiring module, configured to acquire information on the liquid level in the cleaning tank; and
a fourth processing module, configured to control the working state of the liquid discharge device based on the information on the liquid level.

Embodiments of the present disclosure provide a base station. The base station includes a processor and a memory. The memory stores a computer program instruction executable by the processor. When the processor executes the computer program instruction, the steps of the washing method according to any of the above embodiments are realized.

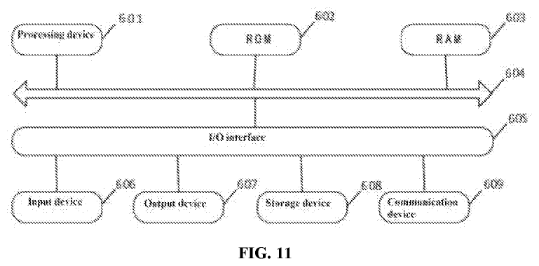

As shown in FIG. 11, the base station may include a processing device 601 (such as a central processing unit, a graphics processor, etc.) that may execute various appropriate actions and processing operations according to a program stored in a read-only memory (ROM) 602 or a program loaded from a storage device 608 into a random access memory (RAM) 603. The RAM 603 also stores various programs and data required for operation of an electronic robot. The processing device 601, the ROM 602, and the RAM 603 are connected to one another via a bus 604. An input/output (I/O) interface is also connected to the bus 604.

Usually, the following devices may be connected to the I/O interface 605: input devices 606 including, for example, a touchscreen, a touchpad, a keyboard, a mouse, a camera, a microphone, and a sensing device; output devices 607 including, for example, a liquid crystal display (LCD), a loudspeaker, and a vibrator; storage devices 608 including, for example, a hard disk; and a communication device 609. The communication device 609 may allow the base station to communicate with another robot in a wireless or wired way to exchange data. For example, the communication device 609 may achieve the communication between the base station and the cleaning robot or a remote mobile device. Although FIG. 11 shows a base station with various devices, it should be understood that it is not required to implement or provide all the shown devices. Alternatively, more or fewer devices may be implemented or provided.

In particular, according to the embodiments of the present disclosure, the process described above in reference to the flowchart may be implemented as a robot software program. For example, an embodiment of the present disclosure includes a robot software program product that includes a computer program carried on a readable medium. The computer program includes program codes used to perform the method shown in the flowchart FIG. 9. In such an embodiment, the computer program may be downloaded and installed from a network via the communication device 609, installed from the storage device 608, or installed from the ROM 602. When the computer program is executed by the processing device 601, the foregoing functions defined in the method in the embodiments of the present disclosure are executed.

It should be noted that the foregoing computer-readable medium in the present disclosure may be a computer-readable signal medium, a computer-readable storage medium, or a combination of the two. The computer-readable storage medium may be, for example, an electrical, magnetic, optical, electromagnetic, infrared, or semiconductor system, apparatus, or device, or any combination thereof. More specific examples of the computer-readable storage medium may include, but are not limited to, an electrical connection having one or more conducting wires, a portable computer disk, a hard disk, a random-access memory (RAM) 603, a read-only memory (ROM) 602, an erasable programmable read-only memory (EPROM 602 or flash memory), an optical fiber, a portable compact disk read-only memory (CD-ROM 602), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. In the present disclosure, the computer-readable signal medium may include a data signal propagated in a baseband or as a part of a carrier, which carries computer-readable program codes. Such a propagated data signal may be in multiple forms, including, but not limited to, an electromagnetic signal, an optical signal, or a combination thereof. The computer-readable signal medium may further be any computer-readable medium other than the computer-readable storage medium. The computer-readable signal medium may send, propagate, or transmit a program that is used by or in combination with an instruction execution system, apparatus, or device. The program code included in the computer-readable medium may be transmitted by using any suitable medium, including but not limited to a wire, an optical cable, a radio frequency (RF), or any suitable combination thereof.

The computer-readable medium may be included in the foregoing robot or may exist separately and not be assembled into the robot.

Computer program codes for performing the operations of the present disclosure may be written in one or more programming languages or a combination thereof. The programming languages include object-oriented programming languages such as Java, Smalltalk, and C++; conventional procedural programming languages such as “C”; or similar programming languages. The program codes may be executed completely on a user computer, partially on a user computer, as an independent package, partially on a user computer and partially on a remote computer, or completely on a remote computer or server.

In a case involving the remote computer, the remote computer may be connected to a user computer through any type of network, including a local area network (LAN) or a wide area network (WAN), or may be connected to an external computer (for example, through the Internet by using an Internet service provider).

Flowcharts and block diagrams in the accompanying drawings illustrate possible architectures, functions, and operations of systems, methods, and computer program products according to various embodiments of the present disclosure. In this regard, each block in a flowchart or block diagram may represent a module, a program segment, or part of code that includes one or more executable instructions for implementing a specified logical function. It should also be noted that in some alternative implementations, functions marked in the blocks may also occur in a different order than those marked in the accompanying drawings. For example, two blocks represented in succession may actually be executed substantially in parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The device embodiments described above are merely schematic. The units described as separated components may or may not be physically separated. The components displayed as units may or may not be physical units. That is, they may be located in one place or may be distributed on a plurality of network units. Part or all of the modules may be selected according to actual needs to achieve the purposes of the solutions in the embodiments of the present disclosure, which can be understood and implemented by those of ordinary skill in the art with minimal creative effort.

It should be noted, finally, that the above embodiments are only intended to describe the technical solutions of the present disclosure and are not intended to limit the present disclosure. Although the present disclosure is described in detail with reference to the foregoing embodiments, it may be understood by those of ordinary skill in the art that it remains possible to make modifications to the technical solutions disclosed in the above various embodiments or make equivalent replacements for some technical features. These modifications or replacements do not divorce from the nature of the corresponding technical solutions from the spirit and scope of the technical solutions in the various embodiments of the present disclosure.

1-14. (canceled)

15. A washing method for a base station to be used cooperatively with a cleaning robot, wherein
the base station comprises a base station body and a washing assembly;
the washing assembly is movably disposed on the base station body; and
the washing method comprises:
acquiring second relative position information of the washing assembly and the base station body; and
controlling an initial running direction of the washing assembly according to the second relative position information.

16. The washing method according to claim 15, wherein
the base station body is provided with a first side edge and a second side edge opposite each other, and
the washing assembly is configured to reciprocate between the first side edge and the second side edge.

17. The washing method according to claim 16, wherein
acquiring the second relative position information of the washing assembly and the base station body, and controlling the initial running direction of the washing assembly according to the second relative position information, comprise:
determining whether a distance between the washing assembly and a first side edge of the base station body is greater than or equal to a distance between the washing assembly and a second side edge of the base station body; and
controlling the washing assembly to move in the direction of the first side edge of the base station body when the distance between the washing assembly and the first side edge of the base station body is greater than or equal to the distance between the washing assembly and the second side edge of the base station body.

18. The washing method according to claim 16, further comprising:
after the washing assembly arrives at the first side edge of the base station body, controlling the washing assembly to move in the direction of the second side edge of the base station body.

19. The washing method according to claim 15, further comprising:
controlling the washing assembly to move in the direction of and arrive at a preset position of the base station body in response to a washing end instruction.

20. The washing method according to claim 16, wherein acquiring the second relative position information of the washing assembly and the base station body comprises:
acquiring a second relative position relationship between the washing assembly and the base station body via a sensing device and a signal transmission device, wherein the sensing device and the signal transmission device are disposed on the base station body and the washing assembly, respectively.

21. The washing method according to claim 20, wherein
a first sensing device is disposed near the first side edge of the base station body, a second sensing device is disposed near the second side edge of the base station body, and/or a third sensing device is disposed near the preset position of the base station body; and
acquiring the second relative position relationship between the washing assembly and the base station body via the sensing device and the signal transmission device comprises at least one of:
determining that the washing assembly arrives at the first side edge of the base station body when the signal transmission device is detected by the first sensing device;
determining that the washing assembly arrives at the second side edge of the base station body when the signal transmission device is detected by the second sensing device; or
determining that the washing assembly arrives at the preset position of the base station body when the signal transmission device is detected by the third sensing device.

22. The washing method according to claim 15, wherein
the washing assembly comprises a first washing component and a second washing component, wherein the first washing component and the second washing component are disposed side-by-side and configured to interfere with a cleaning system of the cleaning robot to remove debris on the cleaning system;
the base station further comprises a liquid discharge device, wherein a cleaning liquid discharged from the liquid discharge device is used to wash the cleaning system; and
the washing method further comprises:
acquiring first relative position information of the first washing component and the second washing component;
acquiring a running direction of the washing assembly relative to the base station body; and
controlling a working state of the washing assembly and a working state of the liquid discharge device according to the first relative position information and the running direction.

23. The washing method according to claim 22, wherein
the first washing component comprises a washing squeegee, and the second washing component is rotatable around a rotation axis; and
controlling the working state of the washing assembly comprises:
controlling a rotation state of the second washing component.

24. The washing method according to claim 23, wherein
controlling the working state of the washing assembly and the working state of the liquid discharge device according to the first relative position information and the running direction comprises:
when the second washing component is located in front of the first washing component in a movement direction of the washing assembly, controlling the second washing component to rotate; and
controlling the liquid discharge device to work

25. The washing method according to claim 24, wherein
the liquid discharge device is disposed side-by-side with the first washing component and the second washing component; and
controlling the liquid discharge device to work comprises:
controlling the liquid discharge device, which is located in front of the first washing component in the movement direction, to work.

26. The washing method according to claim 22, wherein
the base station further comprises a cleaning tank located below the washing assembly; and
the washing method further comprises:
acquiring information on a liquid level in the cleaning tank; and
controlling the working state of the liquid discharge device based on the information on the liquid level.

27. A base station, comprising a processor and a memory, wherein
the memory is configured to store an operation instruction; and
the processor is configured to perform a washing method, wherein
the base station comprises a base station body and a washing assembly;
the washing assembly is movably disposed on the base station body; and
the washing method comprises:
acquiring second relative position information of the washing assembly and the base station body; and
controlling an initial running direction of the washing assembly according to the second relative position information.

28. The base station according to claim 27, wherein
the base station body is provided with a first side edge and a second side edge opposite to each other, and
the washing assembly is configured to reciprocate between the first side edge and the second side edge.

29. The base station according to claim 28, wherein
acquiring the second relative position information of the washing assembly and the base station body, and controlling the initial running direction of the washing assembly according to the second relative position information, comprise:
determining whether a distance between the washing assembly and a first side edge of the base station body is greater than or equal to a distance between the washing assembly and a second side edge of the base station body; and
controlling the washing assembly to move in the direction of the first side edge of the base station body, when the distance between the washing assembly and the first side edge of the base station body is greater than or equal to the distance between the washing assembly and the second side edge of the base station body.

30. The base station according to claim 28, further comprising:
after the washing assembly arrives at the first side edge of the base station body, controlling the washing assembly to move in the direction of the second side edge of the base station body.

31. The base station according to claim 27, further comprising:
controlling the washing assembly to move in the direction of and arrive at a preset position of the base station body in response to a washing end instruction.

32. The base station according to claim 28, wherein acquiring the second relative position information of the washing assembly and the base station body comprises:
acquiring a second relative position relationship between the washing assembly and the base station body via a sensing device and a signal transmission device, wherein the sensing device and the signal transmission device are disposed on the base station body and the washing assembly, respectively.

33. The washing method according to claim 27, wherein
the washing assembly comprises a first washing component and a second washing component, wherein the first washing component and the second washing component are disposed side-by-side and configured to interfere with a cleaning system of the cleaning robot to remove debris on the cleaning system;
the base station further comprises a liquid discharge device, wherein a cleaning liquid discharged from the liquid discharge device is used to wash the cleaning system; and
the washing method further comprises:
acquiring first relative position information of the first washing component and the second washing component;
acquiring a running direction of the washing assembly relative to the base station body; and
controlling a working state of the washing assembly and a working state of the liquid discharge device according to the first relative position information and the running direction.

34. A computer-readable storage medium having a computer program stored thereon, wherein the computer program is configured to, when executed by a processor, implement a washing method, wherein
the base station comprises a base station body and a washing assembly;
the washing assembly is movably disposed on the base station body; and
the washing method comprises:
acquiring second relative position information of the washing assembly and the base station body; and
controlling an initial running direction of the washing assembly according to the second relative position information.
